(19) United States
(12) Patent Application Publication
(10) Pub. No.: US 2019/0389518 A1
(43) Pub. Date: Dec. 26, 2019

(54) GYRO CART

(71) Applicant: Sung Eun YUNG, Cheonan-si (KR)

(72) Inventor: Sung Eun YOUN, Cheonan-si (KR)

(21) Appl. No.: 16/449,330

(22) Filed: Jun. 21, 2019

(30) Foreign Application Priority Data
Jun. 22, 2018 (KR) 10-2018-0072355

(51) Int. Cl. B62D 37/06; B62D 1/16; B62D 51/02

(52) U.S. Cl. CPC B62D 37/06; F16F 15/30; B62D 51/02; B62D 1/16

(57) ABSTRACT

Provided is a gyro cart which is stably maintained in posture through a relatively simple structure when the gyro cart turns. The gyro cart includes a body, a pair of gyro units each including a rotatable flywheel and installed at both ends with respect to a running direction of the body, a steering device formed at the body and rotated by a driver to control a running direction of the body, a direction detecting unit detecting whether the steering device is rotating, a rotation direction of the steering device, and a rotation degree of the steering device, and a controller selectively operating the flywheel included in the gyro unit according to whether the steering device is rotating, the rotation direction of the steering device, and the rotation degree of the steering device detected by the direction detecting unit.

### CROSS-REFERENCE TO RELATED APPLICATIONS

This application claims priority under 35 U.S.C. § 119 to Korean Patent Application No. 10-2018-0072355, filed on Jun. 22, 2018, in the Korean Intellectual Property Office, the disclosure of which is incorporated herein by reference in its entirety.

### TECHNICAL FIELD

The following disclosure relates to a gyro cart, and more particularly, to a gyro cart which is prevented from being overturned using the principle of a gyroscope to preserve the momentum based on a rotational force generated as a flywheel of the gyroscope installed in the cart rotates when the cart turns to run.

### BACKGROUND

An electronic stability control (ESC) is built in recently released vehicles to prevent an accident by controlling a brake, an engine output, and the like, according to a speed, rotation, slip, or position of vehicles.

Although vehicles have a built-in device such as an ESC, carts which are used to operate or which are used for delivery in a certain facility, such as a golf course, do not include the above-described ESC but are manufactured to have a simple structure including a power source or a steering device for financial reasons or for a relatively stable running environment (not a fast speed, determined route, etc.) in many cases.

As described above, a cart having a simple structure has a relatively tall vehicle body to thus have a high center of gravity, and since the cart does not have a separate ESC, the cart may be overturned due to a centrifugal force acting on the cart when rotating, while running at a relatively high speed. In particular, when a lot of luggage is loaded on the cart, the center of gravity becomes higher so that when a centrifugal force is generated, the cart may be more easily overturned, leading to problems that a running speed of the cart is limited or the cart needs to be operated by a skilled driver, which are the problems to be solved.

### RELATED ART DOCUMENT

[Patent document]

Korean Patent Registration No. 10-1840650 (Entitled “Electric Cart for Transporting Freight”, published on Mar. 15, 2018)

### SUMMARY

An exemplary embodiment of the present invention is directed to providing a gyro cart which is stabilized in posture according to directions in which a driver operates the cart through a relatively simple configuration, thereby being prevented from being overturned when rotated.

In one general aspect, a gyro cart includes: a body; a pair of gyro units each including a rotatable flywheel and installed at both ends with respect to a running direction of the body; a steering device formed at the body and rotated by a driver to control a running direction of the body; a direction detecting unit detecting whether the steering device is rotating, a rotation direction of the steering device, and a rotation degree of the steering device; and a controller selectively operating the flywheel included in the gyro unit according to whether the steering device is rotating, the rotation direction of the steering device, and the rotation degree of the steering device detected by the direction detecting unit.

The controller may rotate the flywheel included in a first gyro unit positioned in a rotation direction when the driver rotates the steering device.

The controller may rotate the flywheel included in a second gyro unit positioned in an opposite direction of rotation when the driver rotates the steering device, and a rotation speed of the flywheel included in the first gyro unit is faster than a rotation speed of the flywheel included in the second gyro unit.

The controller may increase or decrease the rotation speed of the flywheel included in the first gyro unit according to the rotation degree of the steering device or the running speed of the body.

A direction of a rotation axis of the flywheel is the same as the running direction of the body.

The gyro unit may include a rotary unit for rotating the flywheel.

A single gyro unit may include at least one flywheel disposed in the running direction.

The single gyro unit may include a plurality of the flywheels and further include a plurality of rotary units for rotating the plurality of flywheels, respectively.

The gyro cart may further include an up-down adjusting unit adjusting an up-down position of the flywheel, and the controller may operate the up-down adjusting unit according to a rotation degree of the steering device or a running speed of the body.

The up-down adjusting unit may include a rotary unit installed at the body, a rotating unit coupled to a rotary shaft of the rotary unit and rotating at a predetermined angle, and a rod connecting the rotating unit and the gyro unit, the gyro unit may be hinge-coupled to the body and rotate at a predetermined angle with respect to a portion hinge-coupled to the body according to rotation of the rotating unit, and the controller may adjust an up-down position of the gyro unit by rotating the rotating unit according to a rotation degree of the steering device or a running speed of the body.

Other features and aspects will be apparent from the following detailed description, the drawings, and the claims.

### BRIEF DESCRIPTION OF THE DRAWINGS

FIGS. 1 and 2 are perspective views of a gyro cart according to an exemplary embodiment of the present invention.

FIG. 3 is a schematic view of an upper part and a rear part of a gyro cart when the gyro cart goes straight according to an exemplary embodiment of the present invention.

FIG. 4 is a schematic view of an upper part and a rear part of a gyro cart when the gyro cart turns right according to an exemplary embodiment of the present invention.

FIG. 5 is a schematic view of an upper part and a rear part of the gyro cart when the gyro cart turns left according to an exemplary embodiment of the present invention.

FIG. 6 is a perspective view of an up-down adjusting unit and a gyro unit according to an exemplary embodiment of the present invention.

FIG. 7 is a rear schematic view of a gyro cart and a rear schematic view of an up-down adjusting unit and a gyro unit according to an exemplary embodiment of the present invention.

### DETAILED DESCRIPTION OF EXEMPLARY EMBODIMENTS

Hereinafter, exemplary embodiments of the gyro cart according to the present invention will be described in detail with reference to the accompanying drawings.

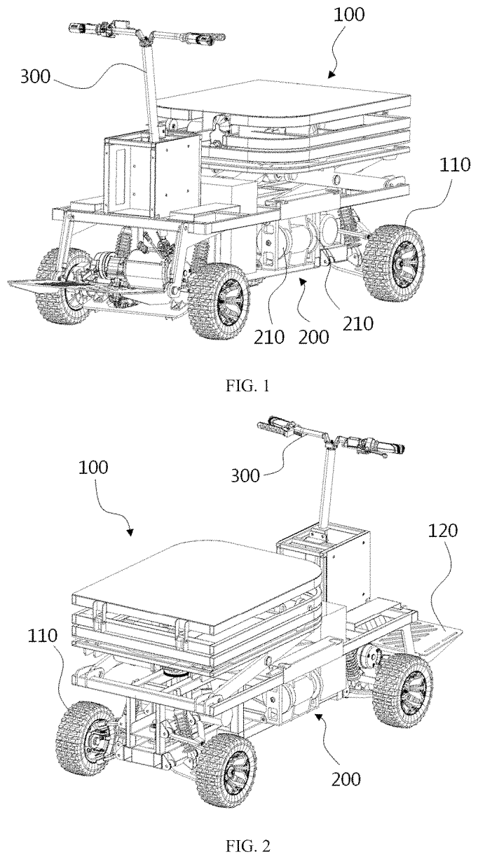

FIGS. 1 and 2 are perspective views of a gyro cart at different angles according to an exemplary embodiment of the present invention.

As illustrated in FIGS. 1 and 2, a gyro cart according to an exemplary embodiment of the present invention includes a body 100, a gyro unit 200, a steering device 300, a direction detecting unit (not shown), and a controller (not shown).

The body 100 is a part in which various devices for driving the gyro cart according to an exemplary embodiment of the present invention are installed. As shown in FIG. 2, a foot-hold 120 on which a driver may stand aboard in the rear in terms of characteristics of the cart, and a space for loading a load may be formed on a front side. That is, in the exemplary embodiment of the present invention shown in FIGS. 1 and 2, the driver stands on the rear side to operate the gyro cart, while gripping a steering device 300.

However, a configuration of the body 100 of the present invention is not limited to FIG. 2 and, in an exemplary embodiment, a separate seat may be provided for the driver/occupant.

A steering wheel 110 provided on the body 100 is installed on a front side of the body 100 and physically connected to the steering device 300. The steering wheel 110 may be changed in direction as the driver operates the steering device 300.

As illustrated in FIGS. 1 and 2, the gyro unit 200 includes a flywheel 210 which does not rotate or rotates according to an operation of a controller (to be described later). The gyro units 200 are installed at both ends with respect to a running direction of the body 100, i.e., a running direction of the gyro cart, respectively. Distances between the gyro units 200 provided at both ends of the body 100 and a central portion of the body 100 may be equal to each other.

The gyro unit 200 controls a balance of the gyro cart by adjusting a rotation and a degree of rotation of the flywheel 210 according to a rotation direction of the gyro cart according to an exemplary embodiment of the present invention.

Each of the gyro units 200 provided at both ends of the body 100 may operate separately.

For the operation of the gyro unit 200 described above, the gyro unit 200 may include a rotary unit (not shown) for rotating the flywheel 210. The rotary units included in the gyro units 200 installed at both ends of the body 100 may be individually controlled by the controller (to be described later). The rotary units may be generally used motors.

The flywheel 210 is rotated by a rotary unit and generates inertia.

A rotation axis of the flywheel 210 is the same as a moving direction of the cart, and a single gyro unit 200 may include at least one flywheel 210. In the exemplary embodiment illustrated in FIG. 2, two flywheels 210 are included in the single gyro unit 200, and the two flywheels 210 included in the single gyro unit 200 are installed abreast in the moving direction of the cart.

When the two flywheels 210 are formed on the single gyro unit 200 as shown in FIGS. 1 and 2, both of the two flywheels 210 may be rotated using a single rotary unit. However, the present invention is not limited thereto. The rotary units 220 respectively rotating the flywheels 210 included in the gyro unit 200 may be provided to correspond to the number of the flywheels 210, and in an exemplary embodiment, the single rotary unit 220 may rotate two or more flywheels 210 connected to the same rotary shaft.

The steering device 300 may be a general handle formed on the body 100 to operate the body, that is, the moving direction of the cart, and may be the general handle as shown in FIGS. 1 and 2. However, the present invention is not limited thereto and various types of steering device 300 may be provided.

The direction detecting unit may detect a rotation direction of the steering device 300 operated by the driver, and the rotation direction of the steering device 300 detected by the direction detecting unit is transmitted to the controller (to be described later).

The direction detecting unit not only detects the direction in which the steering device 300 is rotated but also detects a degree of rotation of the steering device 300 when the gyro cart according to the present invention turns right or left.

The controller selectively operates the gyro unit 200 according to the rotation direction of the steering device detected by the direction detecting unit. Here, the controller operates the rotary unit 220 included in the gyro unit 200 to rotate the flywheel 210. A speed of the flywheel 210 rotated by the controller may vary depending on the degree of rotation of the steering device 300 detected by the direction detecting unit and a running speed of the body.

For the operation of the controller described above, the direction detecting unit may include a communication unit capable of transmitting the detected rotation direction and the degree of rotation of the steering device 300 to the controller, and the body 100 may also include a communication unit capable of transmitting the running speed to the controller.

The reason why the controller changes the speed of the flywheel 210 that the controller rotates according to the degree of rotation of the steering device 300 detected by the direction detecting unit and the running speed of the body is because a generated centrifugal force is varied depending on the degree of rotation and running speed of the gyro cart, and thus, the inertia generated in the flywheel 210 needs to be changed in order to stabilize the posture of the gyro cart.

Hereinafter, the operation of the gyro cart according to the exemplary embodiment of the present invention will be described in detail.

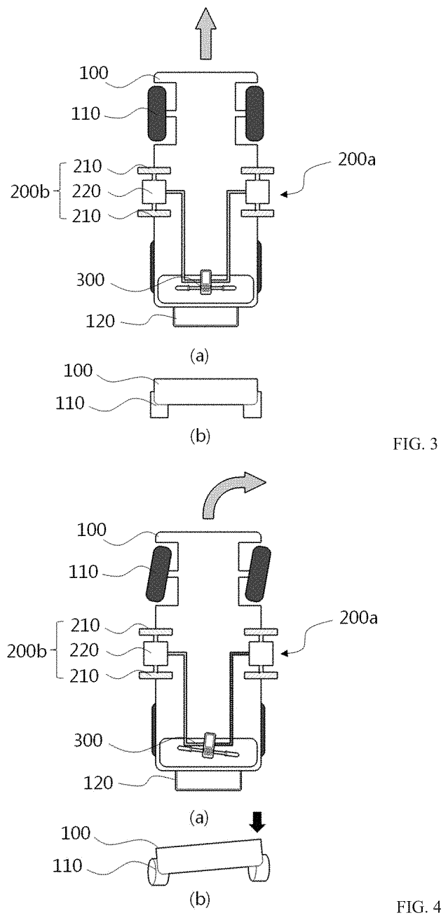

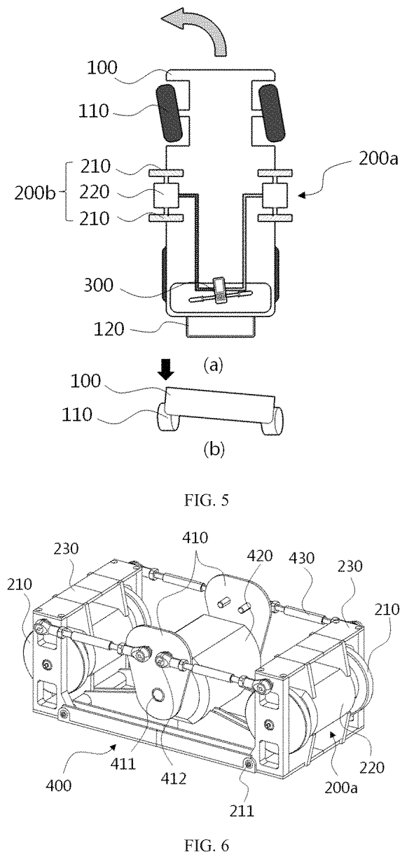

FIGS. 3 to 5 schematically illustrate a gyro cart according to an exemplary embodiment of the present invention as viewed from above and from behind, respectively. Specifically, FIG. 3 illustrates a case where a gyro cart according to an exemplary embodiment of the present invention goes straight, FIG. 4 illustrates a case where the gyro cart according to an exemplary embodiment of the present invention turns right, and FIG. 5 illustrates a case where the gyro cart according to an exemplary embodiment of the present invention turns left.

In FIGS. 3 to 5, in order to distinguish the gyro units respectively installed on the right and left sides of the body 100, the gyro unit 200 positioned on the right side is assigned a subscript a in the figure number and the gyro unit 200 positioned on the left side is assigned a subscript b in the figure number.

As illustrated in FIGS. 3 to 5, in the gyro cart according to the exemplary embodiment of the present invention, the controller may recognize whether the gyro cart according to an exemplary embodiment of the present invention is currently going straight, is turning right, or is turning left according to the direction of the steering device 300 detected by the direction detecting unit.

First as illustrated in FIG. 3, when the gyro cart according to an exemplary embodiment of the present invention goes straight, the controller may not operate both the gyro units 200a and 200b installed at both ends of the body 100.

As shown in FIG. 3A, the reason why the controller does not operate both the gyro units 200 when the gyro cart according to an exemplary embodiment of the present invention goes straight is because a centrifugal force does not act on the gyro cart when the gyro cart goes straight, and thus, neither side of the body 100 of the gyro cart is lifted and the cart stably runs as illustrated in FIG. 3B, eliminating the necessity of separately controlling the posture

As illustrated in FIG. 3, not only when the body 100 of the gyro cart goes straight but also when the rotation angle is within a predetermined angle even when the gyro cart turns right/left, the controller may not operate any of the gyro units 200. This is because, when the gyro turns right or left with a small degree of rotation (within a predetermined angle), a centrifugal force acting on one of both sides of the gyro cart is so small as to have a small effect on the posture of the gyro cart.

However, the degree of rotation (the predetermined angle), which is a reference based on which the controller does not operate the gyro unit 200 may vary depending on a running speed of the gyro cart according to the present invention. Specifically, when the running speed of the gyro cart is fast, the predetermined angle as an operation reference of the gyro unit 200 may be reduced, and when the running speed of the gyro cart is slow, the predetermined angle as the operation reference of the gyro unit 200 may be increased.

When the gyro cart according to an exemplary embodiment of the present invention turns right as shown in FIG. 4A, the right side of the gyro cart may be lifted due to a centrifugal force as shown in FIG. 4B. In this case, the controller rotates the flywheel 210 included in the first gyro unit 200a positioned on the right side of the body 100 on the right side at a predetermined speed to increase an inertia of the right side of the gyro cart where the first gyro unit 200a is positioned. The first gyro unit 200a refers to the gyro unit 200 positioned in a direction in which the gyro cart turns, and the first gyro unit may vary depending on the direction in which the gyro cart turns.

Since the rotating object, i.e., the rotating flywheel 210, has an inertia greater than when it is not rotating, a force is applied to the lower side due to the inertia increased according to rotation of the flywheel 210 included in the first gyro unit 200a even though the right side of the gyro cart according to the present invention is lifted as illustrated in FIG. 4B, and thus, the right side of the body 100 may be prevented from being lifted, stably maintaining the posture of the gyro cart.

A timing at which the controller operates the flywheel 210 is when the driver rotates the steering device 300 to the right. When the driver rotates the steering device 300 to the right, the direction detecting unit transmits, to the controller, the fact that the driver has rotated the steering device 300 to the right and the degree of rotation of the steering device 300, and the controller rotates the flywheel 210 at a predetermined speed by operating the rotary unit 220 included in the first gyro unit 200a positioned on the right side in consideration of the rotation direction of the steering device 300, the speed of the gyro cart, and the degree to which the driver has rotated the steering device 300.

In the case of FIG. 4, the flywheel 210 may rotate in a clockwise direction when the flywheel 210 is viewed from the rear side.

In the state illustrated in FIG. 4, the controller may operate the second gyro unit 200b as well when operating the first gyro unit 200a. Here, a rotation speed of the flywheel 210 of the first gyro unit 200a may be several times to several tens of times faster than the flywheel 210 of the second gyro unit 200b, and this is to reduce vibrations that may occur in the body 100 and to balance the flywheels 210 by operating both flywheels 210 positioned on both sides of the body 100.

When the gyro cart according to an exemplary embodiment of the present invention turns left as shown in FIG. 5A, the left side of the gyro cart may be lifted due to a centrifugal force as shown in FIG. 5B. Here, the controller may rotate the flywheel 210 included in the first gyro unit 200a positioned on the right side of the body 100 at a predetermined speed on the left side to increase the inertia of the left side of the gyro cart where the first gyro unit 200a is positioned to apply a force to the lower side on the left side of the gyro cart, thereby stably maintaining the posture of the gyro cart.

A timing at which the controller operates the flywheel 210 of the first gyro unit 200a is when the driver rotates the steering device 300 to the left. When the driver rotates the steering device 300 to the left, the direction detecting unit transmits, to the controller, the fact that the driver has rotated the steering device 300 to the left and the degree of rotation of the steering device 300, and the controller rotates the flywheel 210 at a predetermined speed by operating the rotary unit 220 included in the first gyro unit 200a positioned on the left side in consideration of the rotation direction of the steering device 300 operated by the user, the speed of the gyro cart, and the degree to which the driver has rotated the steering device 300.

The rotation speed of the flywheel 210 may vary depending on the running speed of the body 100 and the rotation angle of the steering device 300. This is because, as the rotation speed of the flywheel 210 increases, the inertia increases to increase a force applied to the lower side from the position where the flywheel 210 is installed. That is, the controller may increase or decrease the rotation speed of the flywheel 210 according to the running speed of the body 100 or the rotation angle of the steering device 300.

In the case of FIG. 5, a rotation direction of the flywheel 210 may be opposite to a clockwise direction when the flywheel 210 is viewed from the rear side.

In the state shown in FIG. 5, the controller may operate the second gyro unit 200b as well when operating the first gyro unit 200a. Here, a rotation speed of the flywheel 210 of the first gyro unit 200a may be several times to several tens of times faster than the flywheel 210 of the second gyro unit 200b, and this is to balance the flywheel 210 of the first gyro unit 200a and the flywheel 210 of the second gyro unit 200b.

In FIGS. 4 and 5, the situation in which the controller operates the flywheel of the first gyro unit positioned in the direction in which the steering device 300 rotates may continue for a predetermined period of time even after the right turn or the left turn ends. This is because, when the driver turns the gyros cart according to the present invention, the steering device 300, which has been rotated to the right or to the left, may be reversely rotated to its original position, while turning of the gyro cart is ongoing, and here, the gyro cart itself may be in the course of being rotated and a centrifugal force may still be acting on the gyro cart although the steering device 300 is released.

Therefore, the gyro cart according to an exemplary embodiment of the present invention may further include a balance detecting unit for detecting whether the body 100 is balanced, and the controller may stop the flywheel included in the first gyro unit on the basis of whether the body 100 is balanced as measured by the balance detecting unit, rather than the steering device 300, when operating the first gyro unit by the steering device 300.

The balance detecting unit detects not only a left/right balance of the body 100 but also a front/rear balance.

As shown in FIGS. 3 to 5, the gyro cart according to the exemplary embodiment of the present invention includes a plurality of flywheels 210 arranged side by side in the running direction of the gyro cart. The flywheels 210 included in the single gyro unit may be rotated through the single rotary unit 220, but the present invention is not limited thereto. That is, in an exemplary embodiment, rotary units 220 may be separately provided to drive the flywheels 210 included in the single gyro unit to rotate the flywheels 210 positioned on the front side/rear side at separate speeds, respectively, or masses of the flywheels 210 may be different to differentiate inertias generated by the flywheels 210, respectively.

In the exemplary embodiment described above with reference to FIG. 3, the controller does not operate the gyro units 200 positioned on both sides when the gyro cart goes straight, but the present invention is not limited thereto and in a state in which separate posture controlling is not required, the flywheels 210 of the gyro units 200 installed at both ends of the gyro cart may be rotated at a low speed. Specifically, in a state in which the gyro cart goes straight as illustrated in FIG. 3, when the gyro cart is to turn right or left as illustrated in FIG. 4 or 5, the flywheels 210 must be rapidly rotated at a fast speed, and in this case, an excessive load may be applied to a general driving unit including the rotary unit 220 to cause damage or malfunction. That is, in order to prevent this, the flywheels 210 of the gyro units 200 installed at both ends of the gyro cart may be rotated at a low speed.

FIG. 6 illustrates an up-down adjusting unit 400, which may be added to an exemplary embodiment of the present invention, and gyro units 200a and 200b connected to the up-down adjusting unit 400.

As shown in FIG. 6, the up-down adjusting unit 400 may include a rotating unit 410, a rotary unit 420, and a rod 430.

The rotary unit 420 is a portion fixed in position to the body 100, and may be a general motor.

As shown in FIG. 6, the rotating unit 410 may be coupled to a rotary shaft 411 of the rotary unit 420 and rotate at a predetermined angle. Rotation of the rotating unit 410 by the rotary unit 420 is controlled by the controller, and the controller determines a rotation direction of the rotating unit 410 according to a rotation direction of the steering device 300.

As illustrated in FIG. 6, each rotating unit 410 includes a pair of coupling protrusions 412, and one end of the rod 430 in the form of a piston is hinge-coupled to each coupling protrusion 412. The other end of the rod 430 may be connected to a frame 230 accommodating the flywheel 210 and the rotary unit 220 included in the gyro units 200a and 200b and may be hinge-coupled to the frame 230 as with the one end, and the frame 230 may be rotated about the rotary shaft 211 within a predetermined range according to rotation of the rotating unit 410.

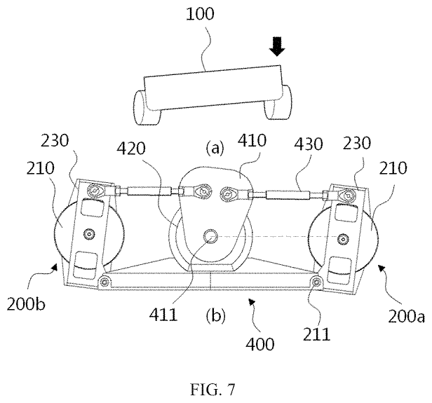

FIG. 7 illustrates an operation of the configuration of the up-down adjusting unit 400. FIG. 7A illustrates a rear side of the gyro cart according to an exemplary embodiment of the present invention when the gyro cart turns right, and FIG. 7B schematically illustrates an operation of the up-down adjusting unit 400f when the gyro cart turns right.

As shown in FIG. 7, when the gyro cart according to an exemplary embodiment of the present invention turns right, the right side of the body 100 may be lifted. When the body 100 turns right (the driver rotates the steering device 300 to the right), the direction detecting unit detects the right turning of the body 100 and transmits the same to the controller and the controller operates the up-down adjusting unit 400.

The operation of the up-down adjusting unit 400 is rotating, by the rotary unit 420, the rotating unit 410 installed to be rotatable at a predetermined angle to the right side (when viewed from behind) with respect to the rotary shaft 411. When the rotating unit 410 is rotated to the right side at the predetermined angle as illustrated in FIG. 7B, the rod 430 hinge-coupled to the coupling protrusion 412 of the rotating unit 410 moves to the right side to push an upper portion of the frame 230 of the gyro unit 200a positioned on the right side, and accordingly, the frame 230 is rotated to the right side at the predetermined angle with respect to the rotary shaft 211.

In this case, a central axis of the flywheel 210 installed inside the frame 230 of the gyro unit 200a positioned on the right side descends to a predetermined degree, as compared with a central axis of the rotating unit 410 as illustrated in FIG. 7, so as to be lower than a state before the rotating unit 410 rotates to the right side, and accordingly, the center of gravity of the right side of the body 100 is lowered to easily stabilize the right side of the body 100 which is a lifted portion.

The rotating unit 410 of the up-down adjusting unit 400 may be returned to its original position when the right turning of the body 100 ends (the rotating unit 410 rotates to the left by a predetermined angle so as to be returned to the state illustrated in FIG. 6), whereby the flywheel 210 of the gyro unit 200a may also be returned to its original position.

The up-down adjusting unit 400 illustrated in FIGS. 6 and 7 is merely an example and is not limited to the present exemplary embodiment, and when one of both sides of the body 100 is lifted as the gyro cart according to the present invention turns, the one side of the body 100 may be stabilized by moving the flywheel 210 positioned in the corresponding direction downwards in various manners.

According to the gyro cart of the present invention as described above, the gyro units provided at both ends of the gyro cart are selectively operated according to an operation of the steering device by the driver, whereby an inertia of one of both sides of the gyro cart may be increased to prevent one side of the cart from being lifted when the cart turns. Therefore, the posture of the cart may be stably maintained through the relatively simple structure when the gyro cart turns, thus preventing the cart from being overturned.

The present invention is not limited to the above-mentioned exemplary embodiments but may be variously applied, and may be variously modified by those skilled in the art to which the present invention pertains without departing from the gist of the present invention claimed in the claims.

1. A gyro cart comprising: a body; a pair of gyro units each including a rotatable flywheel and installed at both ends with respect to a running direction of the body; a steering device formed at the body and rotated by a driver to control a running direction of the body; a direction detecting unit detecting whether the steering device is rotating, a rotation direction of the steering device, and a rotation degree of the steering device; and a controller selectively operating the flywheel included in the gyro unit according to whether the steering device is rotating, the rotation direction of the steering device, and the rotation degree of the steering device detected by the direction detecting unit.

2. The gyro cart of claim 1, wherein the controller rotates the flywheel included in a first gyro unit positioned in a rotation direction when the driver rotates the steering device.

3. The gyro cart of claim 2, wherein the controller rotates the flywheel included in a second gyro unit positioned in an opposite direction of rotation when the driver rotates the steering device, and a rotation speed of the flywheel included in the first gyro unit is faster than a rotation speed of the flywheel included in the second gyro unit.

4. The gyro cart of claim 2, wherein the controller increases or decreases the rotation speed of the flywheel included in the first gyro unit according to the rotation degree of the steering device or the running speed of the body.

5. The gyro cart of claim 1, wherein a direction of a rotation axis of the flywheel is the same as the running direction of the body.

6. The gyro cart of claim 1, wherein the gyro unit includes a rotary unit for rotating the flywheel.

7. The gyro cart of claim 6, wherein the single gyro unit includes at least one flywheel disposed in the running direction.

8. The gyro cart of claim 7, wherein the single gyro unit includes a plurality of the flywheels and further includes a plurality of rotary units for rotating the plurality of flywheels, respectively.

9. The gyro cart of claim 1, further comprising: an up-down adjusting unit adjusting an up-down position of the flywheel, wherein the controller operates the up-down adjusting unit according to a rotation degree of the steering device or a running speed of the body.

10. The gyro cart of claim 9, wherein the up-down adjusting unit includes a rotary unit installed at the body, a rotary unit coupled to a rotary shaft of the rotary unit and rotating at a predetermined angle, and a rod connecting the rotary unit and the gyro unit, the gyro unit is hinge-coupled to the body and rotates at a predetermined angle with respect to a portion hinge-coupled to the body according to rotation of the rotary unit, and the controller adjusts an up-down position of the gyro unit by rotating the rotary unit according to a rotation degree of the steering device or a running speed of the body.
